(19) United States
(12) Patent Application Publication
(10) Pub. No.: US 2004/0129655 A1
(43) Pub. Date: Jul. 8, 2004

(54) Stackable container, paper holder or the like

(76) Inventors: Mario Balzarini, Cremona (IT); Vittorio Balzarini, Cremona (IT)

Correspondence Address: R. Neil Sudol, 714 Colorado Avenue, Bridgeport, CT, 06605-1601, US

(21) Appl. No.: 10/706,764

(22) Filed: Nov. 12, 2003

(30) Foreign Application Priority Data
Nov. 13, 2002 (IT) MI2002 A 002398

(51) Int. Cl. B42F 17/00

(52) U.S. Cl. 211/11

(57) ABSTRACT

A stackable container, paper holder or the like, includes a base that lies on a substantially horizontal plane, a back wall that lies on a substantially vertical plane, and side members, characterized in that the side members include, on each lateral edge of the base, at least one plate that lies substantially at right angles to the edge of the base on a plane that is angled about a vertical axis with respect to the extension of the edge, the edge being furthermore provided with a recess that is adjacent to each one of the plates and is suitable to accommodate one end of a corresponding plate that belongs to an adjacent container that is stacked together with the container, in a storage or shipping condition, the container includes a means for mutually engaging two adjacent containers, the means engaging the adjacent containers in a use condition of the container.

### BACKGROUND OF THE INVENTION

1. Field of the Invention

The present invention relates to a stackable container, paper holder or the like.

2. Description of the Prior Art

Paper holder trays are generally prism-shaped, with open top and front sides: the side walls are generally perpendicular to the bottom and practically all commercially available trays are provided with a means suitable to connect one tray to another in order to stack them.

To reduce space occupation during transport and storage, trays provided with side walls that are inclined so as to allow to insert one tray in the other have become increasingly common.

However, conventional trays with inclined walls do not have adequate connection means for their correct stacking.

The trays are in fact generally laterally offset with respect to each other.

The aim of the present invention is to provide a stackable container that overcomes the drawbacks of the cited known art.

An object of the invention is to provide a stackable container that allows to insert one tray in the other to reduce space occupation when not in use and also allows corrects stacking of the trays.

Another object of the invention is to provide a stackable container that is provided with a connection system that allows to couple one tray to the other simply and rapidly.

Another object is to provide a stackable container that is constructively simple and low-cost.

Another object is to provide a container that can be stacked by virtue of a quick and easy engagement system.

Another object of the invention is to provide a stackable container that combines functional advantages with an interesting and original styling.

### SUMMARY OF THE INVENTION

This aim and these and other objects that will become better apparent hereinafter are achieved by a stackable container, paper holder or the like, which includes a base that lies on a substantially horizontal plane, a back wall that lies on a substantially vertical plane, and side members, characterized in that the side members include, on each lateral edge of the base, at least one plate that lies substantially at right angles to the edge of the base on a plane that is angled about a vertical axis with respect to the extension of the edge, the edge being furthermore provided with a recess that is adjacent to each one of the plates and is suitable to accommodate one end of a corresponding plate that belongs to an adjacent container that is stacked together with the container, in a storage or transport position, the container furthermore including a means for mutually engaging two adjacent containers, the means being suitable to engage the adjacent containers in a position for use of the container.

Further characteristics and advantages will become better apparent from the description of preferred but not exclusive embodiments of the invention, illustrated by way of nonlimiting example in the accompanying drawings.

### BRIEF DESCRIPTION OF THE DRAWINGS

FIG. 1 is an exploded perspective view of a series of stackable trays according to the invention;

FIG. 2 is a top view of the stacked trays;

FIG. 3 is a side view of the stacked trays;

FIG. 4 is a sectional side view, taken along a longitudinal plane, of two trays that are associated in the condition for use;

FIG. 5 is a side view of the two trays of FIG. 4, associated in the condition for use;

FIG. 6 is a perspective view of a tray according to the invention;

FIG. 7 is a perspective view of a tray according to a further aspect of the invention;

FIG. 8 is a perspective view of a tray according to a further aspect of the invention, stacked on a similar tray, shown in dashed lines;

FIG. 9 is a perspective view of the tray of FIG. 8:

FIG. 10 is a partial enlarged-scale perspective view of a detail of the system for mutually coupling the trays shown in FIGS. 8 and 9;

FIG. 11 is a top view of the tray of FIGS. 8-10.

### DESCRIPTION OF THE PREFERRED EMBODIMENTS OF THE INVENTION

With reference to the cited figures, the stackable container, generally designated by the reference numeral 1, comprises a base 2, which lies on a substantially horizontal plane and is connected to a back wall 3 that lies on a substantially vertical plane, and lateral members 4, so as to form an item holder tray.

The tray is preferably formed monolithically, for example by injection-molding.

The lateral members are constituted, on each lateral edge 5 of the base 2, by at least one plate 4 that lies substantially at right angles with respect to the edge 5 of the base 2 on a plane that is angled about a vertical axis 6 at an angle α with respect to the extension of the edge 5.

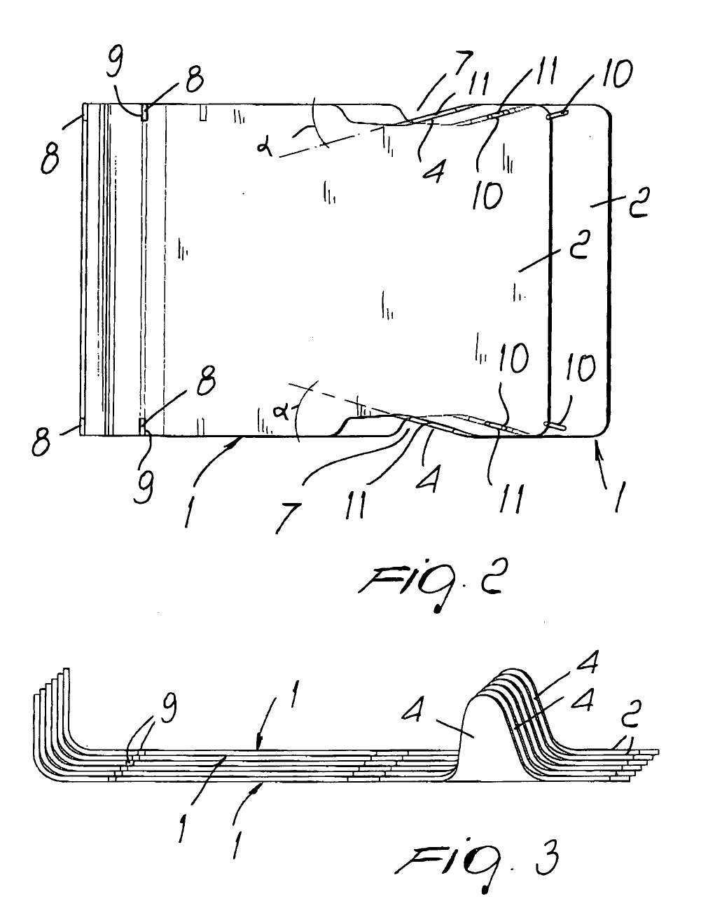

The edge 5 has a recess 7 that is adjacent to each plate 4 and accommodates an end of a corresponding plate 4 that belongs to an adjacent container stacked together with the container being considered, in a storage or shipping condition, shown in FIGS. 2 and 3.

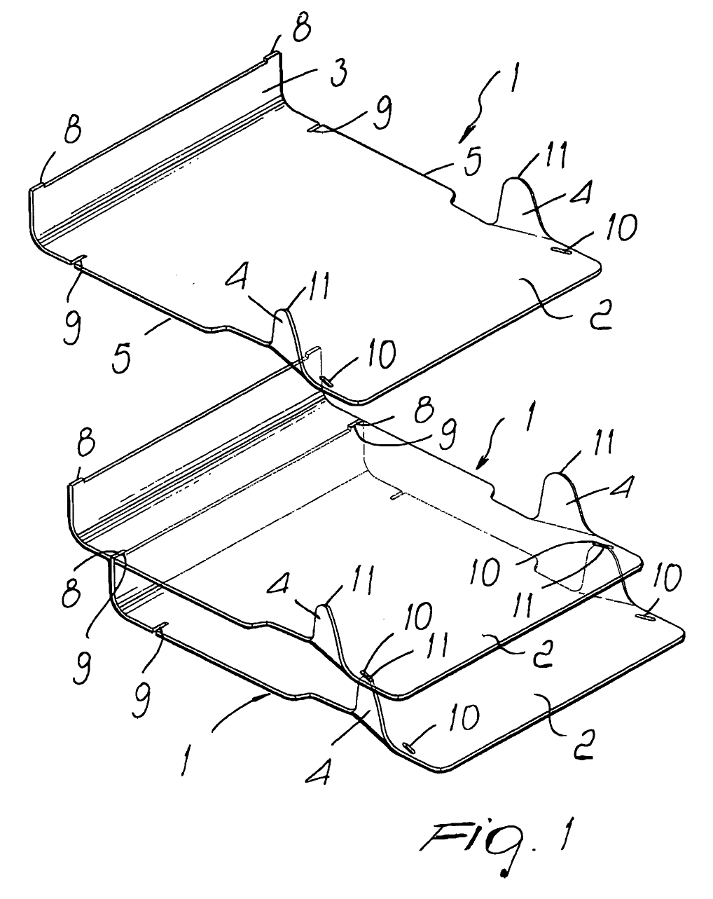

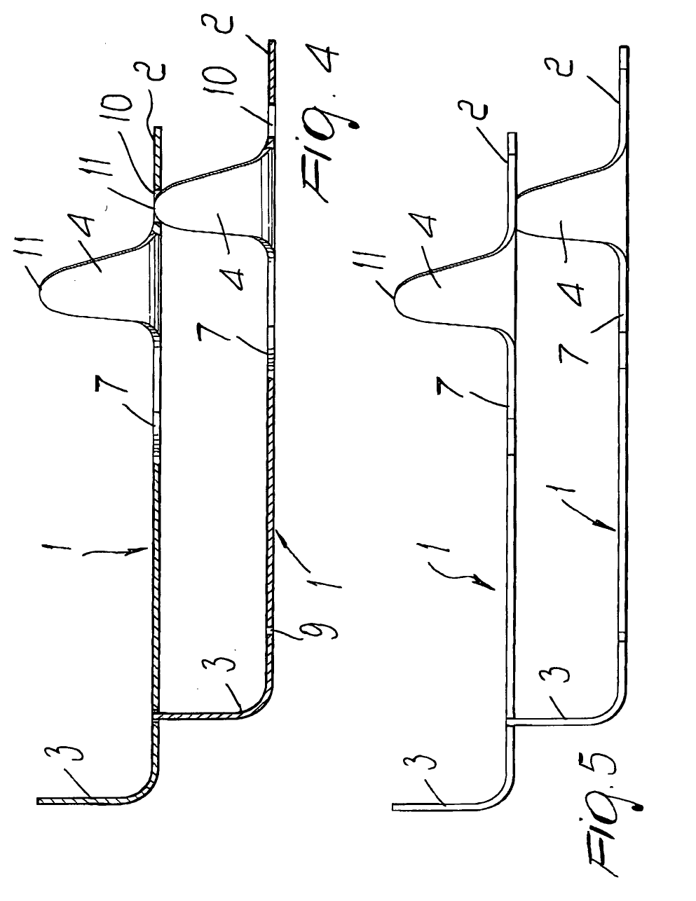

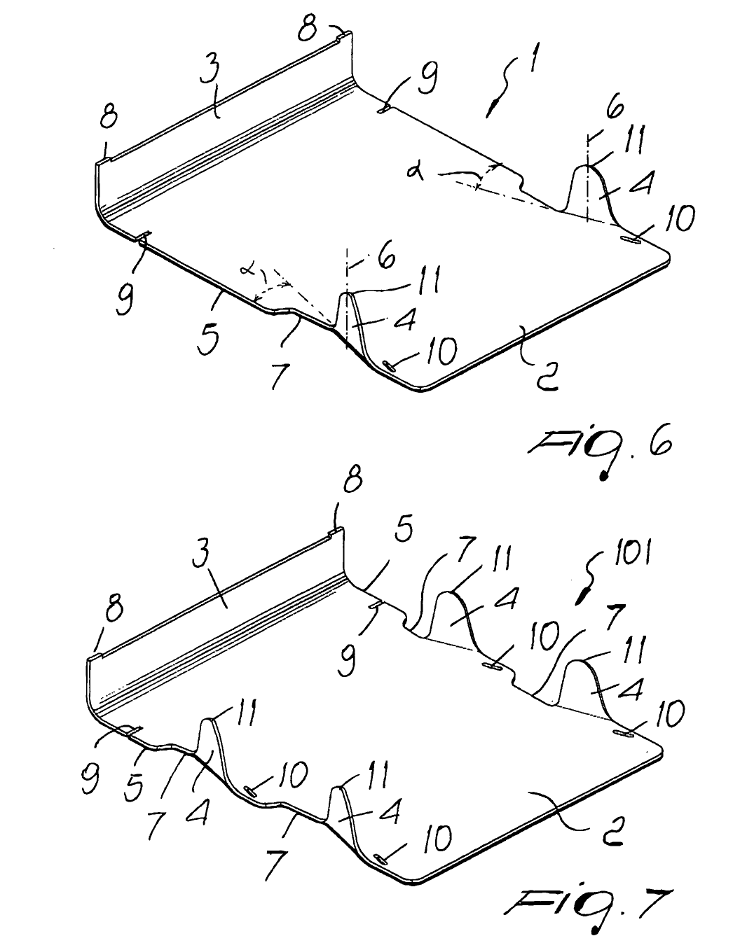

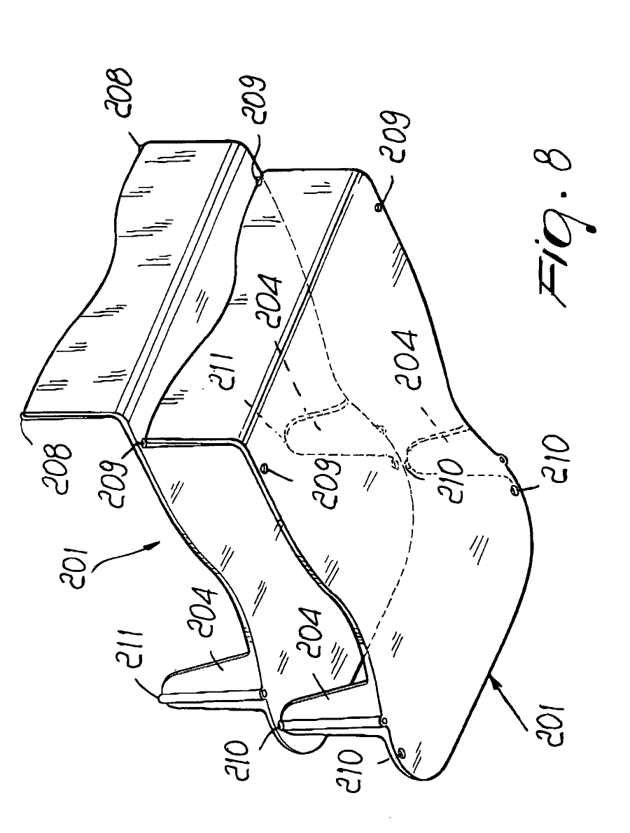

The stackable container according to the invention has a use condition, shown in FIGS. 1, 4 and 5, in which two or more trays 1 can be stacked so that a working internal volume is formed between them.

In the use condition, the trays are associated by an engagement means that comprises two protrusions 8 that are formed at the ends of the free edge of the back wall 3 and engage corresponding notches 9 formed on the lateral edge 5 of an overlying tray.

The engagement means has two angled slots 10, each accommodating the conveniently tapered end 11 of each plate 4 of a similar tray that is stacked below.

FIG. 7 is a view of a container, generally designated by the reference numeral 101, that is similar to the container 1 but is provided with two pairs of plates 4 and corresponding recesses 7 and angled slots 10 instead of a single pair of plates.

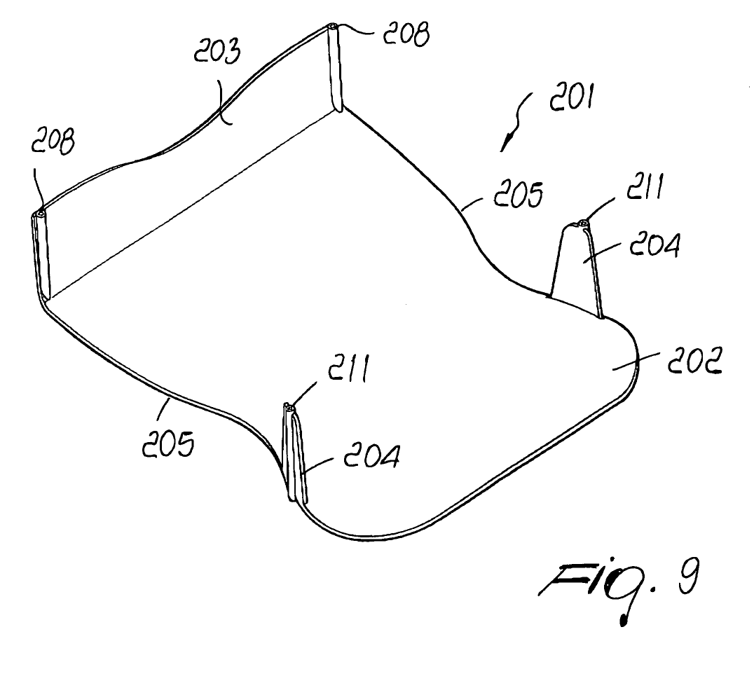

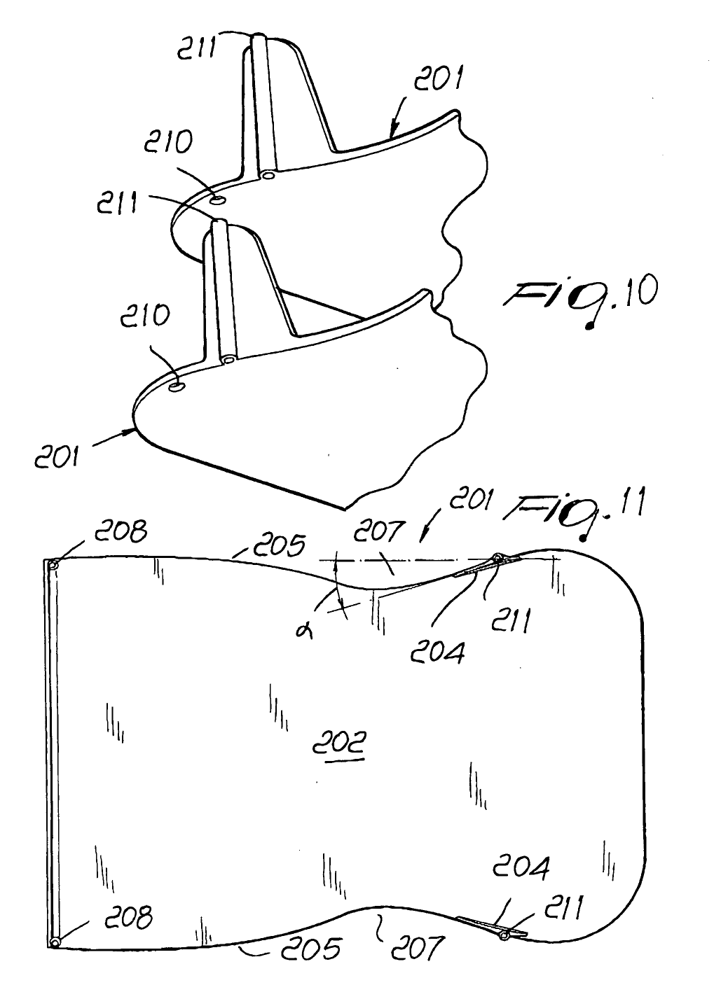

FIGS. 8 to 11 illustrate a container, generally designated by the reference numeral 201, according to the invention, which comprising a base 202, which lies on a substantially horizontal plane and is connected to a back wall 203 that lies on a substantially vertical plane, and side members 204, so as to form an item holder tray.

The tray is formed monolithically, for example by injection-molding.

The lateral members are constituted, on each lateral edge 205 of the base 202, by at least one plate 204 that lies substantially at right angles with respect to the edge 205 of the base 202 on a plane that is angled about a vertical axis 206 at an angle α with respect to the extension of the edge 205.

The edge 205 has a recess 207 that is adjacent to each plate 204 and accommodates an end of a corresponding plate 204 that belongs to an adjacent container that is stacked together with the container being considered, in a storage or shipping condition, similar to the condition shown in FIGS. 2 and 3 of the preceding embodiment.

The stackable container according to the invention also has a use condition, shown in FIG. 8, in which two or more trays 201 can be stacked so that a working internal volume is formed between them.

In the use condition, the trays are associated by an engagement means that comprises two rear protrusions 208 that are formed at the ends of the free edge of the back wall 203 and engage corresponding rear holes 209 formed in the lower surface of the base 202 of an overlying tray.

The engagement means has two front holes 210, each accommodating a front protrusion 211 of each plate 204 of a similar tray that is stacked below.

In practice it has been found that the invention achieves the intended aim and objects, a stackable container having been provided which allows both insertion of one tray in another, in order to reduce space occupation when not in use, and correct stacking of the trays.

The container according to the invention is susceptible of numerous modifications and variations, within the scope of the appended claims All the details may be replaced with technically equivalent elements

The materials used, as well as the dimensions, may of course be any according to the requirements and the state of the art.

1. A stackable container, paper holder or the like, comprising a base that lies on a substantially horizontal plane, a back wall that lies on a substantially vertical plane, and side members, said side members comprising, on each lateral edge of said base, at least one plate that lies substantially at right angles to said edge of the base on a plane that is angled about a vertical axis with respect to the extension of said edge, said edge being provided with a recess that is adjacent to each one of said plates and accommodates one end of a corresponding plate that belongs to an adjacent container that is stacked together with said container, in a storage or shipping condition, said container having a means for mutually engaging two adjacent containers, said means engaging said adjacent containers in a use condition of said container.

2. The container according to claim 1, wherein said engagement means comprises two protrusions that are formed at the ends of the free edge of said back wall and engage corresponding notches formed in the lateral edge of a similar tray that is stacked above.

3. The container according claim 1, wherein said engagement means comprises two angled slots, each accommodating a tapered end of each plate of a similar tray that is stacked below.

4. The container according to claim 1, wherein said engagement means comprises two rear protrusions formed at the ends of the free edge of the back wall and engaging corresponding rear holes formed on the lower surface of the base of an overlying tray.

5. The container according to claim wherein said engagement means comprises two front holes, each accommodating a front protrusion of each plate of a similar tray that is stacked below.
